(19) United States
(12) Patent Application Publication
(10) Pub. No.: US 2012/0201095 A1
(43) Pub. Date: Aug. 9, 2012

(54) SYSTEM AND METHOD FOR PACKAGING AND MIXING MULTI-PART MEDICANT

(76) Inventor: Jeffry S. Melsheimer, Springville, IN (US)

(21) Appl. No.: 13/353,671

(22) Filed: Jan. 19, 2012

Related U.S. Application Data
(60) Provisional application No. 61/440,610, filed on Feb. 8, 2011.

(51) Int. Cl. B01F 13/00; B65D 25/08

(52) U.S. Cl. 366/342; 206/219

(57) ABSTRACT

Disclosed is a system for mixing and dispensing bone cement. The system includes a flexible bag containing isolated liquid and powder components that are reactive with each other to form bone cement and a mixing device that has first and second primary pressure surfaces and first and second secondary curved pressure surfaces. The system allows the bag to attach to the first and second secondary pressure surfaces. The system is operated such that the first primary pressure surface exerts force on the bag against the first secondary pressure surface and the second primary pressure surface exerts force on the bag against the second secondary pressure surface. Relative movement of the primary pressure surfaces with respect to the bag causes mixing of the components within the bag.

### REFERENCE TO RELATED APPLICATION

This application claims the benefit of U.S. Provisional Application No. 61/440,610, filed Feb. 8, 2011, which is hereby incorporated by reference.

### BACKGROUND

The present disclosure concerns a device for mixing components of a medicament together in a practical, safe and convenient way. In particular, the disclosure includes a bone cement mixer for mixing liquid and powder components reactive with each other to form bone cement in a pre-filled container.

Bone cements are used in a variety of orthopedic therapeutic situations, for example to secure bone to bone or to a prosthetic, and generally consists of a liquid component and a powder component. Bone cement sets up over time, so it is desirable to mix the components as close to the time of use as possible in order to complete any procedures before the bone cement cures. Therefore it is common for bone cement to be mixed in the operating theatre just prior to application of the bone cement. The components must be thoroughly mixed in order to create effective cement. However, sometimes it is difficult to achieve a uniform mixture of cement by most conventional mixing methods, such as by manually mixing in a bowl, or by hand manipulation of a bag containing both components. Additionally, the chemical reaction from the mixing process produces undesirable fumes that are troublesome.

### SUMMARY

Disclosed is a bone cement mixer for mixing liquid and powder components in a pre-filled flexible container. The components are at first isolated in a divided bag. The mixing device is lightweight and easily transported. The mixing device has active surfaces that apply pressure to the outside of the container and cause uniform mixing of the components within the container. Optional flowpaths in the flexible container can be shaped to facilitate mixing of the components. An optional tap on one edge of the flexible container allows gas to be purged. An optional tap on another edge of the flexible container allows the bone cement mixture to be dispensed.

### BRIEF DESCRIPTION OF THE FIGURES

FIG. 1 is a perspective view of an embodiment of a system for packaging and mixing a multi-part medicament including a mixing device and a flexible container.

FIG. 2 is an assembly view of the FIG. 1 mixing device.

FIG. 3 is a perspective view of a roller, a component of the FIG. 2 assembly.

FIG. 4 is a perspective view of a drum, an alternative embodiment of a drum of the FIG. 2 assembly.

FIG. 5 is a top plan view of the mixing device of FIG. 1.

FIG. 6 is a bottom perspective view of a swivel arm that couples the FIG. 3 roller and the FIG. 4 drum as shown in the FIG. 2 assembly.

FIG. 6A is a bottom plan view of the FIG. 6 swivel arm.

FIG. 7 is a perspective view of a biasing member positioned between the FIG. 6 swivel arm and the FIG. 4 drum.

FIG. 8 is a perspective view of a swivel mounting mechanism that couples the FIG. 4 drum and the FIG. 1 mixing device as shown in the FIG. 2 assembly.

FIG. 9 is a perspective view of a biasing member that applies relative force between the FIG. 1 mixing device and the FIG. 8 swivel mounting mechanism.

FIG. 10 is perspective view of one embodiment of a flexible container partitioned into two separated compartments by a divider.

FIG. 11 is a bottom perspective view of the FIG. 1 mixing.

FIG. 12 is a perspective view of several components of a driving mechanism, including a motor, a gear reducer, and a crank.

FIG. 13 is a perspective view of a crank connecting arm for the FIG. 11 motion-driving mechanism.

FIG. 14 is a bottom plan view of the FIG. 1 mixing device.

FIG. 15 is a partial side elevational view of the FIG. 1 mixing device showing the interconnections of the drums and rollers with the swivel arms, crank, and crank connecting arm.

FIG. 16A is a top perspective view of the FIG. 1 mixing device.

FIG. 16B is a top perspective view of the FIG. 16A mixing device with the FIG. 6 swivel arms biased in a loading configuration ready to receive the FIG. 10 flexible container.

FIG. 16C is a top perspective view of the FIG. 16B mixing device loaded with the FIG. 10 flexible container.

FIG. 16D is a top perspective view of the FIG. 16C mixing device with the FIG. 6 swivel arms unrestrained and applying force to the FIG. 10 flexible container.

FIG. 17A is a top plan view of the FIG. 16C configuration.

FIG. 17B is a top plan view of the FIG. 16D configuration.

FIG. 17C is a top plan view of the FIG. 17B mixing device illustrating rotation of the drums.

FIG. 18 is a cross-sectional view of an alternative embodiment of the FIG. 10 flexible container.

FIG. 19A is a side elevational view of the FIG. 18 flexible container with FIG. 3 rollers illustrating one arrangement during mixing.

FIG. 19B is a side elevational view of the FIG. 18 flexible container with FIG. 3 rollers illustrating another arrangement during mixing.

FIG. 20A is a side elevational view of the FIG. 18 flexible container with FIG. 3 rollers illustrating another arrangement during venting.

FIG. 20B is a side elevational view of the FIG. 18 flexible container with FIG. 3 rollers illustrating another arrangement during dispensing.

FIG. 21 is a perspective view of an alternative embodiment of a divider.

FIG. 22 is a perspective view of an alternative embodiment of the FIG. 10 flexible container partitioned by the FIG. 21 divider.

FIG. 23A is a cross-sectional view of another alternative embodiment of the flexible container.

FIG. 23B is a cross-sectional view of yet another alternative embodiment of the FIG. 10 flexible container.

FIG. 24 is a cross-sectional view of still another alternative embodiment of the FIG. 10 flexible container.

FIG. 25 is a cross-sectional view of a further alternative embodiment of the FIG. 10 flexible container.

### DETAILED DESCRIPTION

For the purpose of promoting an understanding of the claims, reference will now be made to certain embodiments and possible variations thereof and specific language will be used to describe the same. It should nevertheless be understood that no limitation of the scope of this disclosure and the claims is thereby intended, and that such alterations, further modifications and further applications of the principles described herein are contemplated as would normally occur to one skilled in the art to which the disclosure relates. In several figures, where there are the same or similar elements, those elements are designated with the same or similar reference numerals.

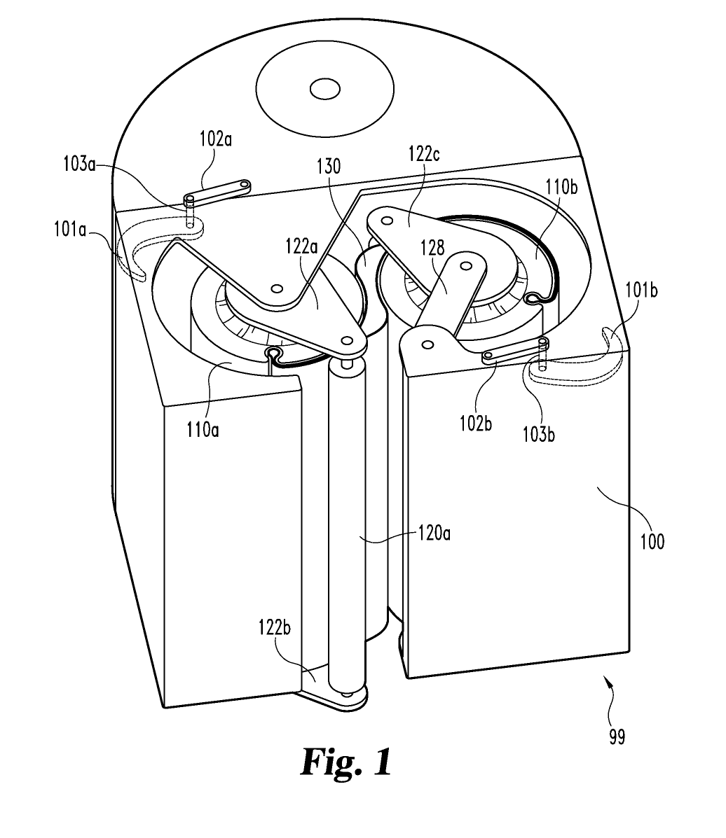

FIG. 1 illustrates a system for packaging and mixing a multi-part medicament including bone cement mixer 99 which includes support structure 100, drum 110a, drum 110b, swivel mounting mechanism 127, roller 120a, roller 120b, swivel arms 122a-d, swivel arms 128a and 128b, and flexible container 130. As illustrated, roller 120a is arranged to rotate radially around drum 110a, and roller 120b is arranged to rotate radially around drum 110b. Drum 110a is rotatably coupled to support structure 100. Drum 110b is rotatably mounted to swivel mounting mechanism 127 which is pivotally coupled to support structure 100.

As described more fully below, flexible container 130 is positioned in bone cement mixer 99 such that contact on flexible container 130 is made between one or more of the following: between drum 110a and roller 120a, between drum 110b and roller 120b, and between drum 110a and drum 110b.

Roller 120 may refer to either and/or both roller 120a and roller 120b, and in various embodiments can be any pressure surface suitable to apply pressure to a flexible container and against a secondary pressure surface including a non-rotating pressure surface (not illustrated). In this context, rollers 120 serve as primary pressure surfaces that keep the bolus of bag contents biased together as the bag is shifted from one extreme to the other. Similarly, drum 110 refers to either drum 110a or drum 110b, and can be any curved pressure surface suitable for a primary pressure surface to apply pressure to a flexible container. In this context, drum 110 serves as a secondary pressure surface.

Drum 110b is rotatably coupled to swivel arms 128a and 128b, which allow both rotational and angular translational motion of drum 110b with respect to support structure 100. Rotatable mounting support 127a laterally supports swivel arms 128a and 128b and rotatably mounts swivel arms 128a and 128b to support structure 100. In each reference to rotatable motion in this description, such rotatable motion can be facilitated by any of several non-enumerated means known to persons skilled in the art, such as axles, bushings, or bearings.

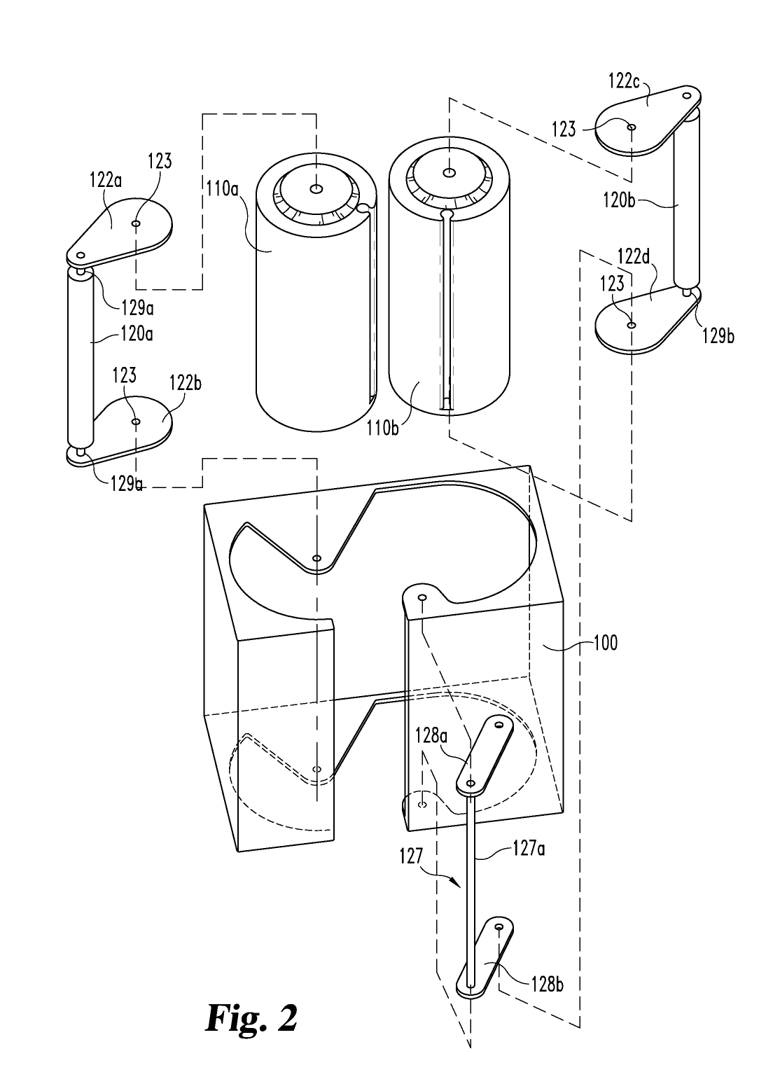

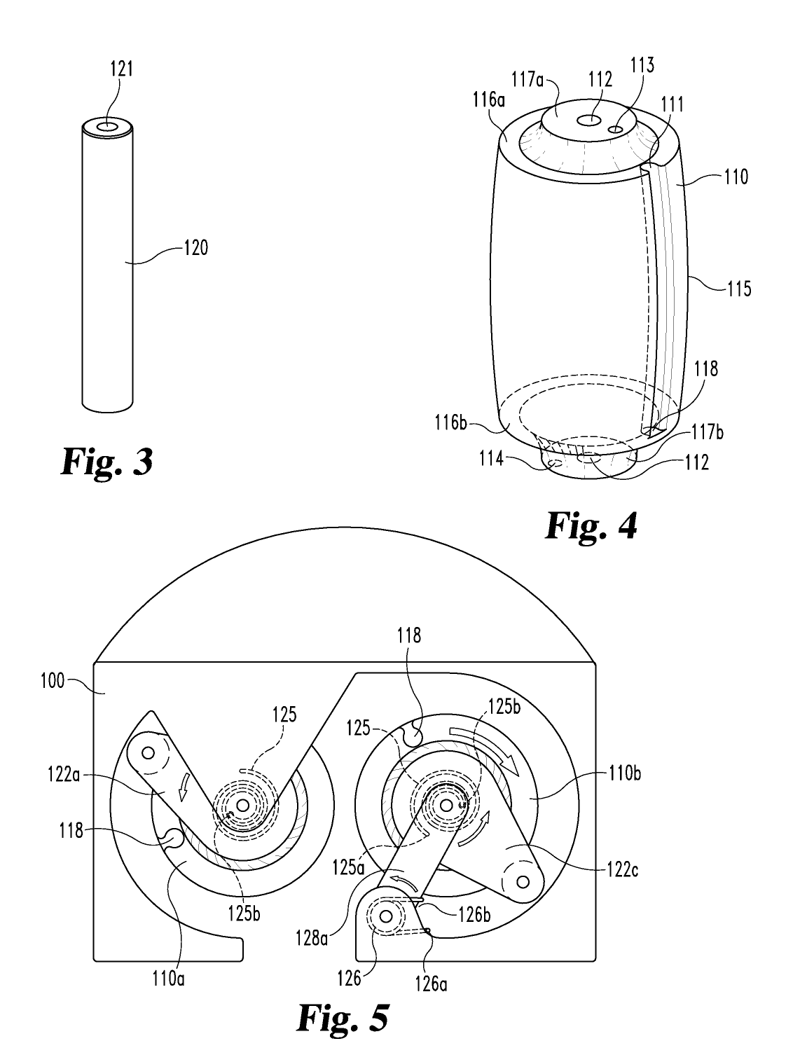

Biasing member 126 (FIG. 5) biases rollers 110a and 110b together which may form a restriction therebetween that may generate shear resistance mixing. FIG. 3 illustrates roller 120 as a cylindrical shape, which can embody both roller 120a and 120b as illustrated in FIG. 2. In other embodiments, roller 120 could be shaped as an elongated non-rotational strip and formed from a compliant material. Roller 120 could also be a solid, non-rotating plough-type structure. In other embodiments, roller 120 can be formed from a rigid material. Roller 120 can also be formed from a compliant material. Alternatively, roller 120 could be formed from a rigid material and covered in a compliant material.

FIG. 3 shows rotatable connection point 121, which could be a center bore that can support an axle. Alternatively, rotatable connection point 121 could be a shallow hole defining a bushing to support other rotatable connection means such as a stub axle. FIG. 2 shows roller 120a rotatably connected to swivel arms 122a and 122b by axle 129a. In the illustrated embodiment, roller 120a has a length shorter than axle 129a to create a separation distance between the bottom surface of swivel arm 122a and the top surface of roller 120a. In other embodiments, roller 120a and axle 129a could be unitarily constructed as one piece.

Drum 110, as illustrated in FIG. 2 is a cylindrically shaped form. FIG. 4 illustrates an alternative embodiment of drum 110 including a slightly convex curvature along its length. However, it will be apparent to one skilled in the art that other suitable shapes could suffice. For example, drum 110 could have a generally half-moon profile (as viewed from above) instead of a generally circular profile.

Drum 110 includes rotatable connection point 112, which in the illustrated embodiment is a center bore running axially through the drum that is constructed and arranged to support an axle. In other embodiments (not illustrated), rotatable connection point 112 could be a shallow hole defining a bushing to support any other rotatable connection means such as a stub axle. In yet other embodiments, drum 110 may incorporate an integral axle.

In the embodiment illustrated in FIG. 4, on drum 110 surface 117a is offset from surface 116a by a separation distance that generally coincides with the separation distance between the top surface of roller 120a and the bottom surface of swivel arm 122a. The bottom of drum 110 has surface 117b and surface 116b, which are also offset by a separation distance similar to that described for the top surfaces 116a and 117a. The offset distance between surfaces 117a and 116a and surfaces 117b and 116b could be achieved by manufacturing a unitary piece to create drum 110. Alternatively, drum 110 could be integrally created from two or more pieces attached together.

Still referring to FIG. 4, drum 110 (in both illustrated embodiments) includes biasing member connection point 113 on surface 117a. Drum 110 also includes mounting channel 111, which, as described below, is operable receive container 130 to couple flexible container 130 to drum 110. Mounting channel 111 terminates near the bottom of drum 110 at channel end 118. Connection point 114, on surface 117b, provides a rotatable connection point for connecting arm 105 (FIG. 13) to drum 110.

In any embodiment, drum 110 may be constructed from a compliant material. Alternatively, drum 110 could be rigidly constructed, and pressure surface 115 could be covered with a compliant material. Pressure surface 115 could be generally straight and cylindrical or tapered from the top and bottom as shown in FIG. 4.

Similarly, roller 120 could be generally straight and cylindrical (FIG. 3) or tapered from the top and bottom (not illustrated) similarly to drum 110 (FIG. 4). In the illustrated embodiment (FIG. 1), the space between the surfaces of rollers 120a and 120b and drums 110a and 110b may be constructed and arranged to be no more than the combined thickness of the walls of container 130.

Referring now to FIG. 5, mechanisms to control the rotational motion of arms 122 and swivel mounting mechanism 127, including swivel arms 122, biasing members 125, and biasing member 126 are shown. Specifically illustrated are swivel arms 122 and 128 and the interaction of swivel arms 122 and 128 with support structure 100 and drums 110a and 110b and biasing members 125 and 126. The illustrated arrows show the direction of force applied by biasing members 125 and 126 to the various components.

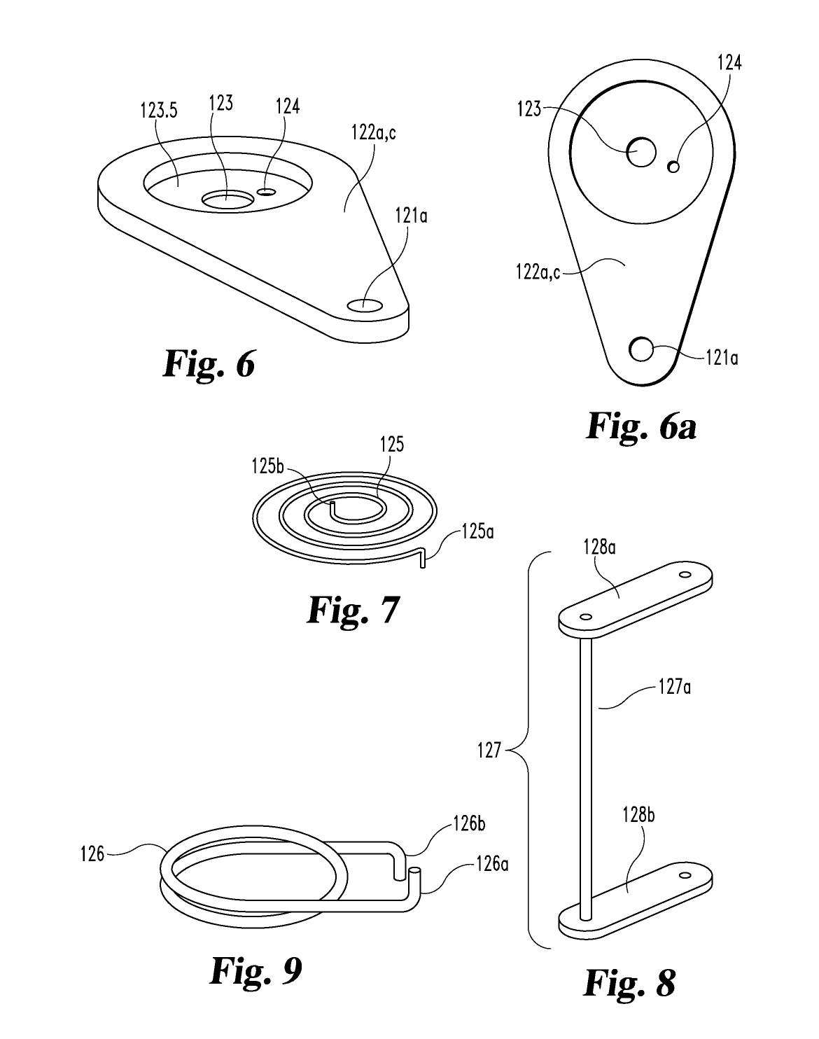

Swivel arms 122a and 122c are illustrated in FIGS. 6 and 6A. Rotatable connection point 121a rotatably connects swivel arm 122a to roller 120a via axle 129a. Rotatable connection point 123 connects swivel arm 122a to drum 110a via connection point 112 (FIG. 4). Cylindrical recession 123.5 has a recessed surface which is offset from the bottom surface of swivel arm 122a. Connection point 124 lies in recessed surface 123.5.

Biasing member 125 is illustrated in FIG. 7. Biasing member 125 has rotatable connection points 125a and 125b. Cylindrical recession 123.5 of swivel arm 122a is offset from the bottom surface of swivel arm 122a by a distance sufficient to allow biasing member 125 to fit between the recessed surface of cylindrical recession 123.5 and surface 117a of drum 110a as illustrated in FIG. 5. Connection point 125a couples with connection point 113 on drum 110a. Connection point 125b couples with connection point 124 on swivel arm 122a. A second biasing member 125 is similarly coupled to drum 110b and swivel arm 122c. Biasing members 125 bias swivel arms 122a and 122c with respect to drums 110a and 110b such that swivel arms 122a and 122c tend to rotate counter-clockwise relative to drums 110a and 110b (and drums 110a and 110b tend to rotate clockwise relative to swivel arms 122a and 122c) with respect to the top plan view of FIG. 5.

Biasing member 126 is illustrated in FIG. 9 and includes connection points 126a and 126b. Biasing member 126 is coupled with swivel mounting mechanism 127, and located between the top surface of swivel arm 128a and a surface of support structure 100. Referring to FIG. 5, biasing member 126 engages swivel arm 128a and support structure 100. Connection point 126a is biased against support structure 100. Connection point 126b is biased against a side edge of swivel arm 128a. Biasing member 126 causes swivel mounting mechanism 127 to tend to rotate counter-clockwise with respect to the top plan view of FIG. 5. This rotational motion produces translational motion of drum 110b with respect to support structure 100.

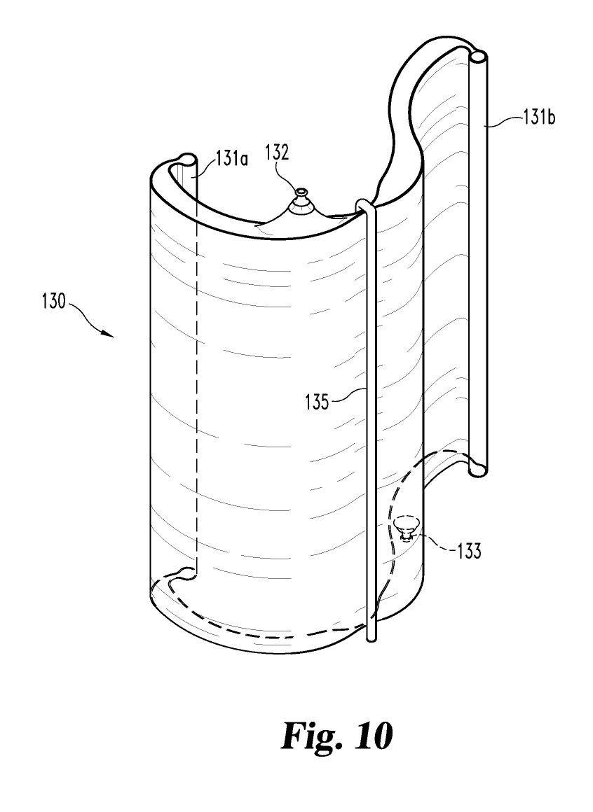

Referring now to FIG. 10, one embodiment of flexible container 130 is shown, including connectors 131a and 131b, gas expulsion tap 132, mixture expulsion tap 133 and divider 135. Flexible container 130 is made of any suitable flexible material. In one embodiment, the container is constructed from two separate, plastic sheets fused at the edges. In another embodiment, the container could be one plastic sheet folded and fused at the edges. The container contains two components. In the illustrated embodiment, one component is a liquid component, and the other component is a powder component that is reactive with the liquid component to form bone cement.

Divider 135 is a removable divider that partitions the two components within the common container 130 until such time as mixing is necessary. Divider 135 in FIG. 10 is shown in one embodiment as a clip with two elongated members that extend along either side of flexible container 130 and apply pressure to flexible container 130 and against each other. The pressure creates a seal within flexible container 130 that prevents one component in one side or compartment of container 130 from physically accessing the other component in the other side or compartment of container 130. When divider 135 is removed, the two components have fluid access to each other.

Gas expulsion tap 132 is fluidly connected to the inside of flexible container 130. Gas expulsion tap 132 can be of a luer lock connection type, and may be operable to expel gases from the flexible container when properly oriented. During mixing, gases can be created as a by-product of a chemical reaction between the reactive components within flexible container 130. Gases also are a residual component of dead space within the powder component. The gases can optionally be expelled via tap 132 into a large capacity syringe, a fume hood or a vacuum device. In any event, whether gasses are expelled from flexible container 130 or retained in flexible container 130, such gasses can optionally be kept isolated from the surrounding environment such as a surgery room. This can be advantageous if the gasses have some undesirable characteristics such as being malodorous and/or noxious.

Mixture expulsion tap 133 is fluidly connected to the inside of flexible container 130. Mixture expulsion tap 133 can of be a luer lock connection type, and may be used to dispense a mixture from the flexible container when properly oriented. This allows bone cement to be expelled into a medical syringe or other appropriate application device. In the illustrated embodiment mixture expulsion tap 133 is located on the bottom side of the container. However, in other embodiments, tap 133 could be located on the top side of the container. The functional descriptions of taps 132 and 133 are dependent upon the orientation of container 130. Either tap can be used for any purpose described herein. Alternatively, flexible container 130 could have only one tap that is operable for both expelling gas, and dispensing mixture. The location of either one or both taps on the container can vary. For example one or both taps could be located at either ends of flexible container 130.

Flexible container 130 can be pre-filled with two components for eventual mixing into a cement compound, e.g. one component in each of the separated compartments of container 130. In another embodiment, the components can be added through either of the taps 132 or 133 after divider 135 is in place. In yet another embodiment, the components could be added through the ends of the container, and then subsequently the ends of the container could be sealed.

Connector 131 may refer to either and/or both connectors 131a and 131b, which are constructed and arranged to connect flexible container 130 to drums 110a and 110b. Coupling channel 111 on drums 110a and 110b may be shaped with an elongated opening width that is less than the maximum channel width. Connector 131 can be a rigid or semi-rigid elongated member with a width or diameter that is greater than the elongated opening width of coupling channel 111. Flexible container 130 can be connected to drum 110a by sliding connector 131 into coupling channel 111 in the axial direction (i.e. along the axis of connector 131) until connector 131 abuts against channel end 118 (FIG. 4), thus allowing the material of flexible container 130 to pass through the elongated opening of channel 111, but restricting connector 131 from passing through the elongated opening of channel 111. Such a connection may allow roller 120a to pass over coupling channel 111 when flexible container 130 is connected without requiring excessive displacement of roller 120a with respect to swivel arms 122a and 122c, or without requiring adjustment of the length of swivel arms 122a and 122c. It should be apparent that other connection parts or structures would be equally suitable.

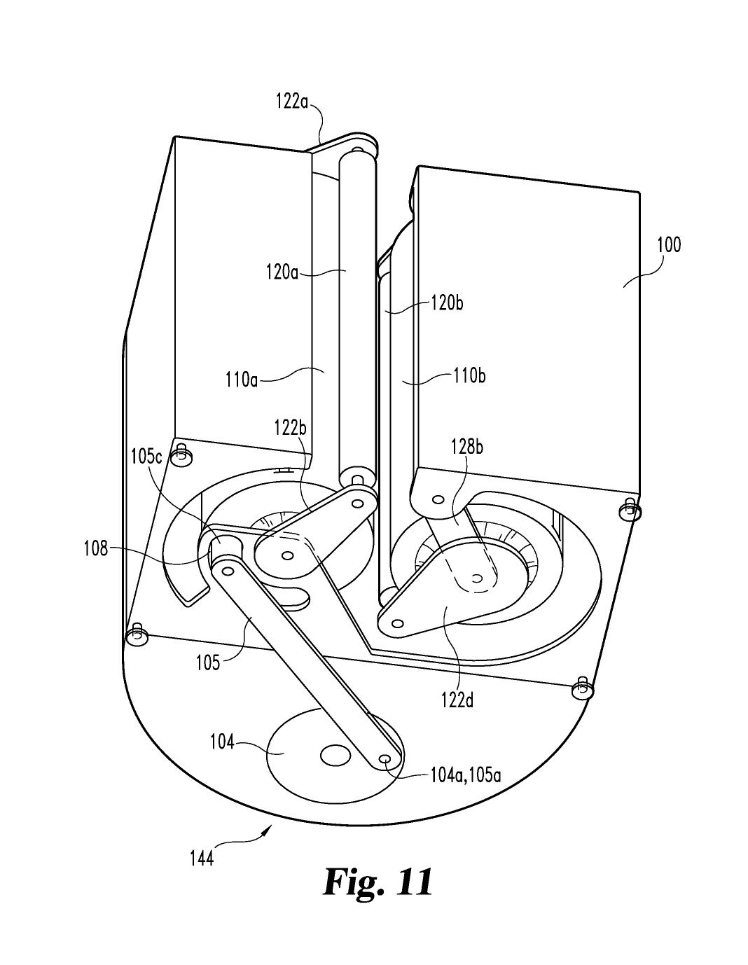

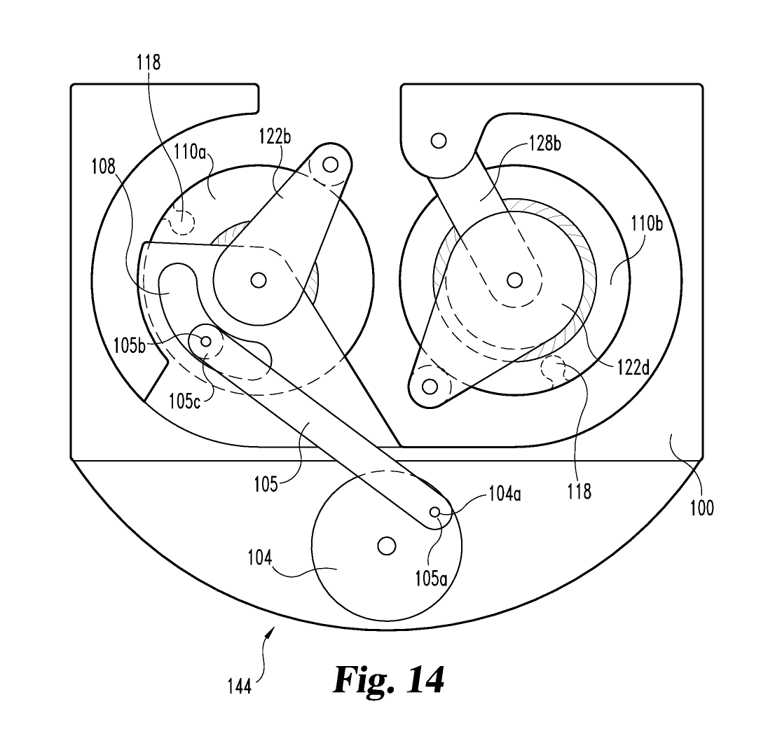

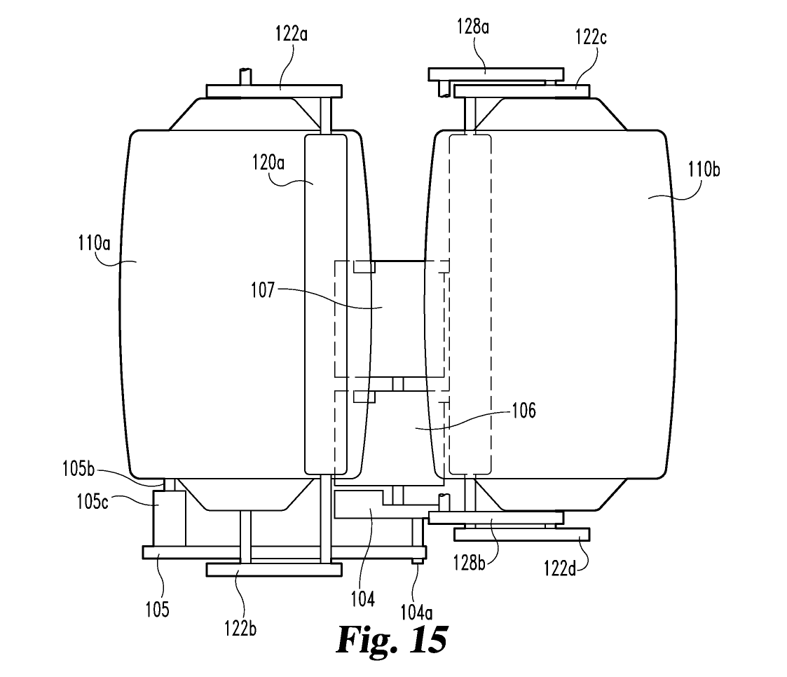

Referring now to FIGS. 11-15, motion-producing mechanism 144 is illustrated, including crank 104, connecting arm 105, gear reducer 106, electric motor 107, and guide channel 108. Motion-producing mechanism 144 as illustrated in FIGS. 11-15 operates as a kinematic linkage with connecting arm 105 as a linking member. Crank 104 is situated in support structure 100 and interacts with connecting arm 105 as shown in FIGS. 11 and 14. Crank connection point 104a is rotatably coupled with connection point 105a. Channel guide 105c is slidingly positioned within guide channel 108 on support structure 100. Connection point 105b is rotatably coupled with connection point 114 on drum 110a (FIG. 4).

Rotation of crank 104 generates reciprocating rotation of drum 110a through the kinematic linkage provided by connecting arm 105. In the illustrated embodiment, as crank 104 is rotated through 180 degrees, connecting arm 105 causes drum 110a to rotate 90 degrees. Continued rotation of crank 104 through an additional 180 degrees (in the same direction) causes drum 110a to rotate 90 degrees in the opposite direction. Thus, rotation of crank 104 through a 360 rotation generates reciprocating rotation of drum 110a through 90 degrees in one direction and 90 degrees in the opposite direction. It should be noted that guide channel 108 is not necessary to achieve the described motion; however it can support both connecting arm 105 and drum 110a with respect to support structure 100.

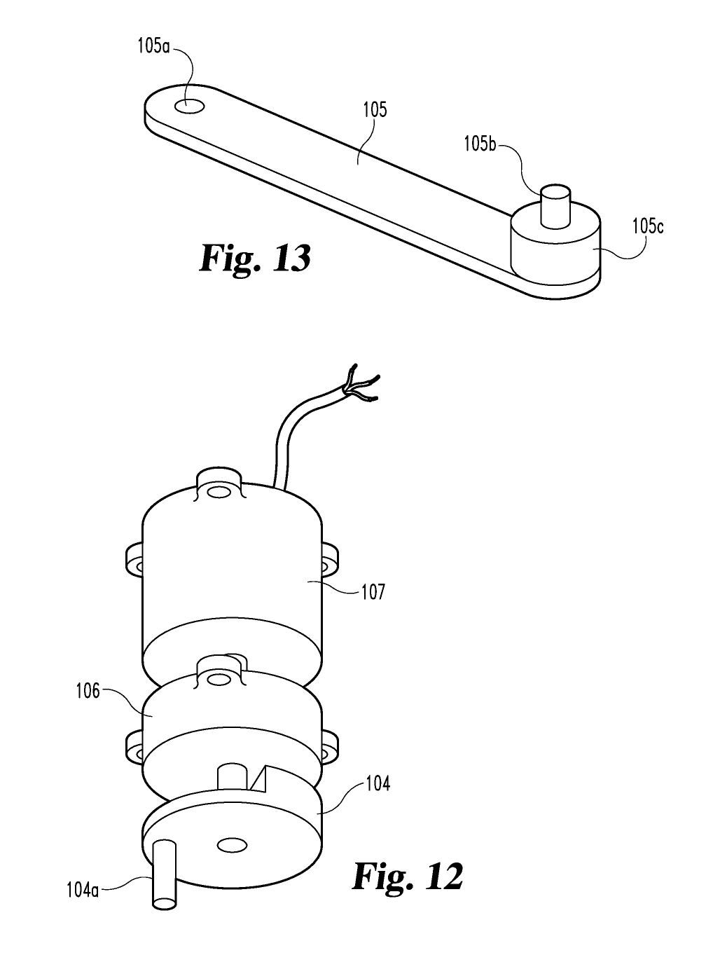

Crank 104 can be a hand crank or other motorized means. FIG. 12 shows one embodiment whereby electric motor 107 drives gear reducer 106 which drives crank 104. In this embodiment, gear reducer 106 reduces the rotational speed of the motor and creates greater torque power applied at crank connection point 104a.

In other embodiments, motion-producing mechanism 144 described above can be achieved using any suitable means in addition to the described embodiment. For example, belts or gears (not pictured) could be used to create motion of drum 110a, whereby crank 104 could be attached to drum 110a via a belt or chain. In such an embodiment, crank 104 and drum 110a could be fixed with a pulley or gear suitable to receive the belt or chain. In this way, rotating motion of crank 104 would cause linear, translational motion of said belt or chain which would interact with the pulley or gear fixed to drum 110a, resulting in rotational motion of drum 110a. Reciprocating motion of drum 110a could be achieved by alternately changing the direction of crank 104.

Alternatively, crank 104 and drum 110a could be fixed with mated gears (not pictured) such that rotational motion of crank 104 causes rotational motion of a gear fixed to crank 104, resulting in rotational motion of a gear fixed to drum 110a and simultaneous rotational motion of drum 110a. Reciprocating motion of drum 110a could be achieved by alternately changing the direction of crank 104.

Use of any of the above discussed means to mix the contexts in flexible container 130 may result in a mixing system that produces consistent mixing characteristics. For example, operating a motorized crank 104 for a period of time or manually revolving crank 104 a set number of times may result in consistently mixing the components contained in flexible container 130 such that a manufacturer could specify mixing parameters in a way that is consistently repeatable. This could be important in some applications because some reactive mixtures have a limited period of time in which they can be administered. Spending excessive time mixing the reactive components may reduce the time available to administer them. Consistent mixing of reactive components may improve application results because the reactive mixture will be consistently adequately mixed and the amount of time available to administer the reactive mixture may be well defined. Consistent mixing also improves batch to batch consistency when multiple mixtures may be required.

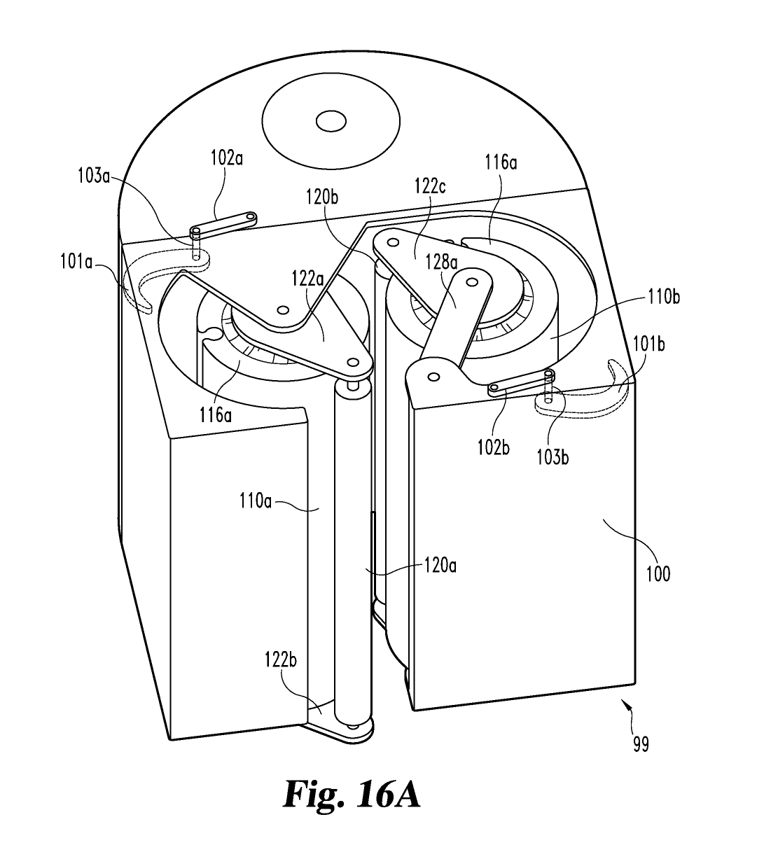

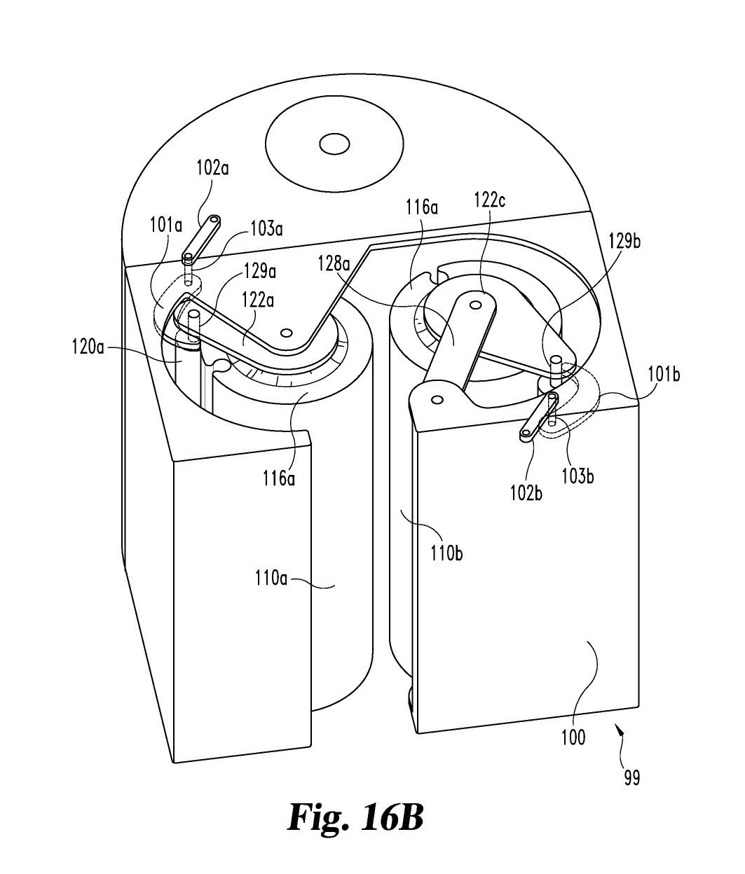

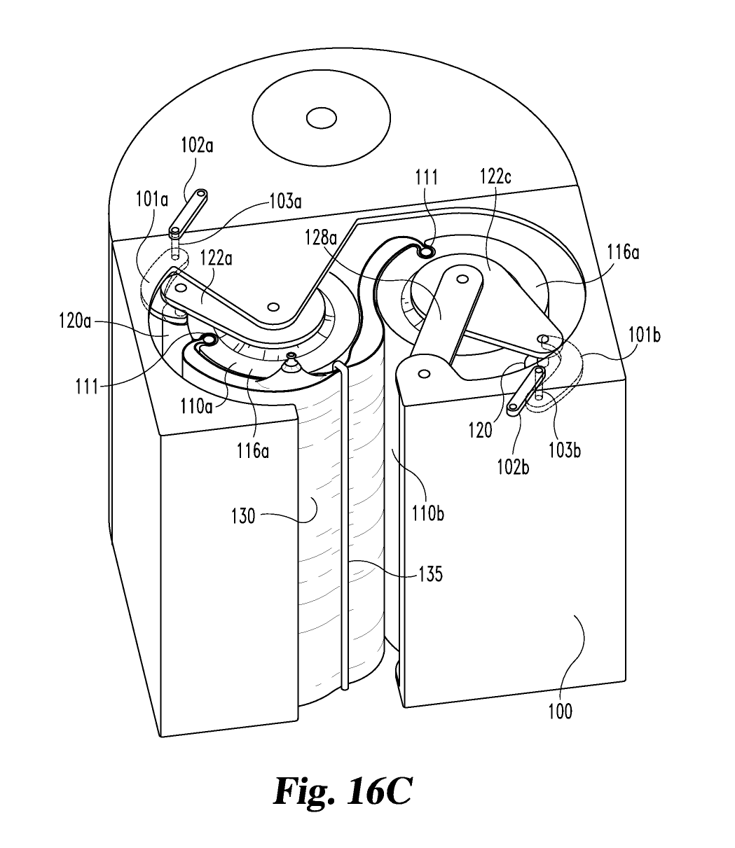

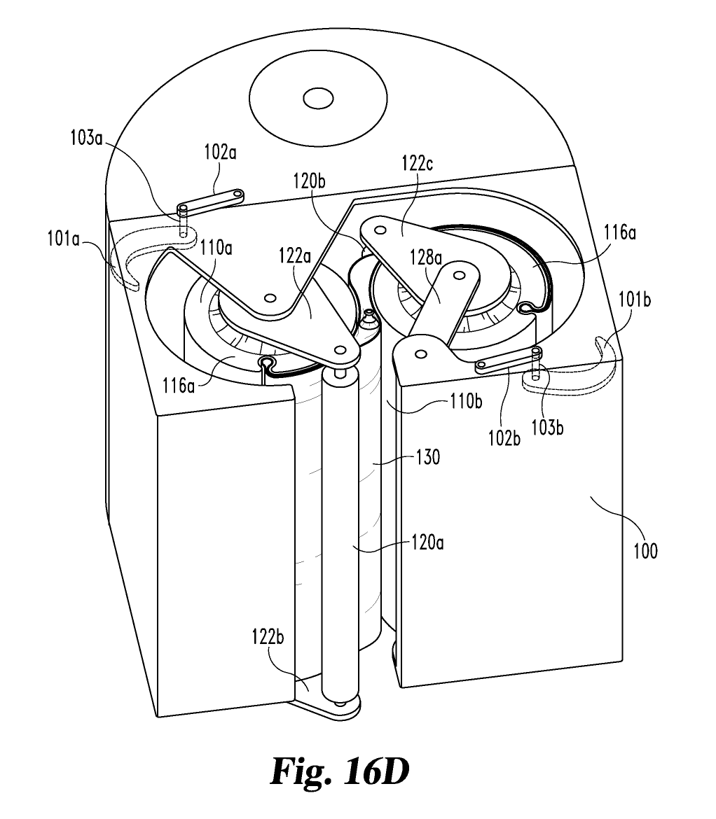

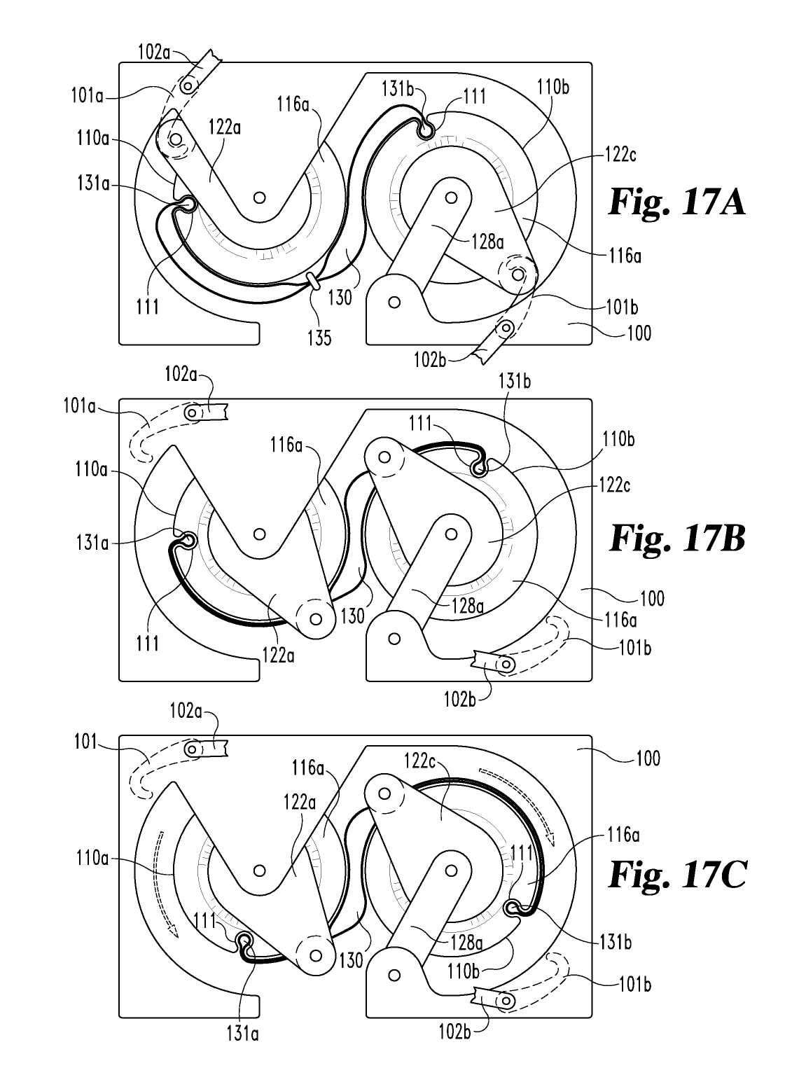

Referring now to FIGS. 16A-17C, several embodiments of the interaction of flexible container 130 with the mixing device are illustrated. FIG. 16A shows mixing device 99 with drums 110, rollers 120, swivel arms 122, swivel mounting mechanism 127, retaining arms 101a and 101b, and handles 102a and 102b. FIG. 16B shows mixing device 99 in a condition that is ready for flexible container 130 to be mounted with swivel arms 122 being biased and restrained in position by retaining arms 101.

Retaining arm 101a and handle 102a are attached to support 103a. Support 103a is rotatably coupled with support structure 100 such that handle 102a is above the top surface of support structure 100 and retaining arm 101a is below the top surface of support structure 100. When handle 102a is pivoted around the location of support 103a, retaining arm 101a simultaneously pivots around the location of support 103a.

Retaining arm 101b and handle 102b are attached to support 103b. Support 103b is rotatably coupled with support structure 100 such that handle 102b is above the top surface of support structure 100 and retaining arm 101b is below the top surface of support structure 100. When handle 102b is pivoted around the location of support 103b, retaining arm 101b simultaneously pivots around the location of support 103b.

The position of drum 110a is rotatably controlled by connecting arm 105 and crank 104 (FIG. 11). Biasing member 125 (FIG. 5) biases swivel arm 122a with respect to drum 110a to position roller 120a near the center area of support structure 100. In FIG. 16B, swivel arm 122a is rotated clockwise and against the biasing force of biasing member 125. Retaining arm 101a is pivoted around support 103a and retaining arm 101a abuts axle 129a to hold swivel arm 122a in place against the bias of its member 125.

Drum 110b can be rotatably and temporarily fixed in place by applying manual pressure to an external surface of drum 110b, such as surface 116a. Biasing member 125 (FIG. 5) biases swivel arm 122c with respect to drum 110b. In FIG. 16B, swivel arm 122c is rotated clockwise and against the biasing force of biasing member 125. Retaining arm 101b is pivoted around support 103b and retaining arm 101b abuts axle 129b to hold swivel arm 122c in place against the bias of its member 125.

In the configuration of FIGS. 16C and 17A, flexible container 130 is mounted to drums 110a and 110b via exposed coupling channels 111 on both drums without interference by either swivel arms 122 or rollers 120 and while one or both of drums 110a, 110b are held in position by their respective arms 101a, 101b. Flexible container 130 is inserted into the mixing device, and connector 131a is inserted into coupling channel 111 of drum 110a until connector 131a abuts channel end 118 of drum 110a, while connector 131b is inserted into coupling channel 111 of drum 110b until connector 131a abuts channel end 118 of drum 110b.

In FIGS. 16C and 17A, divider 135 is attached to flexible container 130. In FIGS. 16D and 17B, divider 135 is removed and handles 102a and 102b are moved to disengage retaining arms 101a and 101b from swivel arms 122a and 122c. With divider 135 removed, the cement components in flexible container 130 can come together to mix, and both components are forced towards the center of flexible container 130 between the connection points of roller 120a and drum 110a, and roller 120b and drum 110b, as shown in FIG. 17B. Swivel arms 122a and 122c rotate counter-clockwise towards the center of support structure 100. Simultaneously, drum 110b rotates clockwise, applying a lateral tensile force to flexible container 130. Biasing member 126 causes drum 110b to apply pressure to the surface of flexible container 130 and against drum 110a.

The offset distances between outer-drum surfaces 116 and inner drum surfaces 117 are configured and arranged to allow adequate clearance for swivel arms 122 to pass over and below expulsion taps 132 and 133. Similarly, the offset distances between swivel arms 122 and rollers 120 are configured and arranged to allow sufficient clearance for taps 132 and 133.

It should be appreciated that means other than biasing members 125 could be used to maintain the rotational relationship between drums 110a and 110b, such as gears or kinematic linkages.

Mixing is achieved by alternating clockwise and counter-clockwise 90 degree rotations of drum 110a and forcing movement of the components within flexible container 130 from one area of flexible container 130 to another area of flexible container 130 due to the surface pressure applied by rollers 120a and 120b on flexible container 130 acting against drums 110a and 110b.

FIG. 17C shows the location of flexible container 130 after a 90 degree counter-clockwise rotation of drum 110a. The components are moved from one area of flexible container 130 to another area of flexible container 130, e.g. each cement component moves toward the other and toward the middle of container 130. The mixing process is continued by rotating drum 110a 90 degrees clockwise back to the state depicted in FIG. 17B, and the process is repeated until the components are sufficiently mixed, or until gas purging is necessary. FIG. 16D is a perspective view of the mixing device in the state depicted in FIG. 17B.

It should be appreciated that the interaction of rollers 120 on drums 110 could be achieved by other suitable embodiments. For example, pressure surface 115 of drums 110a and 110b could be non-cylindrically curved, such that rotatable connection point 123 of swivel arms 122 does not coincide with a circular center-point axis corresponding to pressure surface 115. In such case swivel arms 122 could be integrated with a biasing member to allow a differential distance between rotatable connection point 123 and rotatable connection point 121. Such biasing member could also be used to vary the pressure forces between rollers 120 and drums 110.

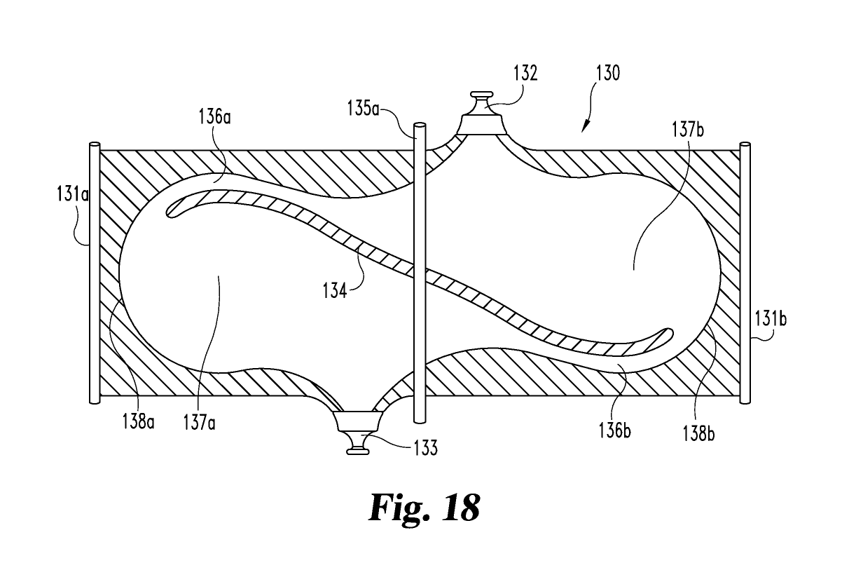

Referring now to FIG. 18, a cross-section of one embodiment of flexible container 130 is illustrated, including interior fused surfaces 134, narrowed flow channels 136a and 136b, chambers 137a and 137b, and rounded chamber walls 138a and 138b. The internal chamber of flexible container 130 is generally bisected by interior fused surfaces 134, creating chambers 137a and 137b.

In one embodiment, interior fused surfaces 134 may be created by externally applying heat to one or both surfaces or plies of flexible container 130, essentially creating a weld that acts as an internal wall subdividing flexible container 130 into multiple chambers. In other embodiments, interior fused surface 134 may be created by any known welding or bonding technique. Alternatively, interior fused surfaces 134 could be created by inserting and attaching additional flexible material between the two surfaces of flexible container 130. Rounded chamber walls 138a and 138b could be similarly created by externally applying heat to one or both surfaces of flexible bag 130 to fuse the surfaces together. In the illustrated embodiment, flexible container 130 is constructed and arranged to have narrowed flow channel 136a that feeds into mixing chamber 137a, and narrowed flow channel 136b that feeds into mixing chamber 137b.

Connectors 131a and 131b can be created by attaching an elongated rigid structure to the ends of flexible container 130 by adhesive. Alternatively, connectors 131a and 131b can be created by wrapping either end of flexible container 130 around an elongated rigid structure and attaching the flexible material back against itself. Alternatively, connectors 131a and 131b can be created by rolling an elongated rigid structure into either end of flexible container 130.

Generically-depicted divider 135a is located in the configuration of FIG. 18 to isolate mixing chamber 137a from mixing chamber 137b. While a mechanical divider is illustrated, any technique to divide mixing chamber 137a and 137b may be used, including, but not limited to, weak internal bonding of interior surfaces. Gas expulsion tap 132 may be fluidly-connected with one mixing chamber, while mixture expulsion tap 133 is fluidly-connected with the other mixing chamber in the case where the two mixing components are loaded into the flexible container through the taps. However, if the flexible container is loaded in a different manner, such as through unsealed edges, the taps need not correspond with separate isolated mixing chambers.

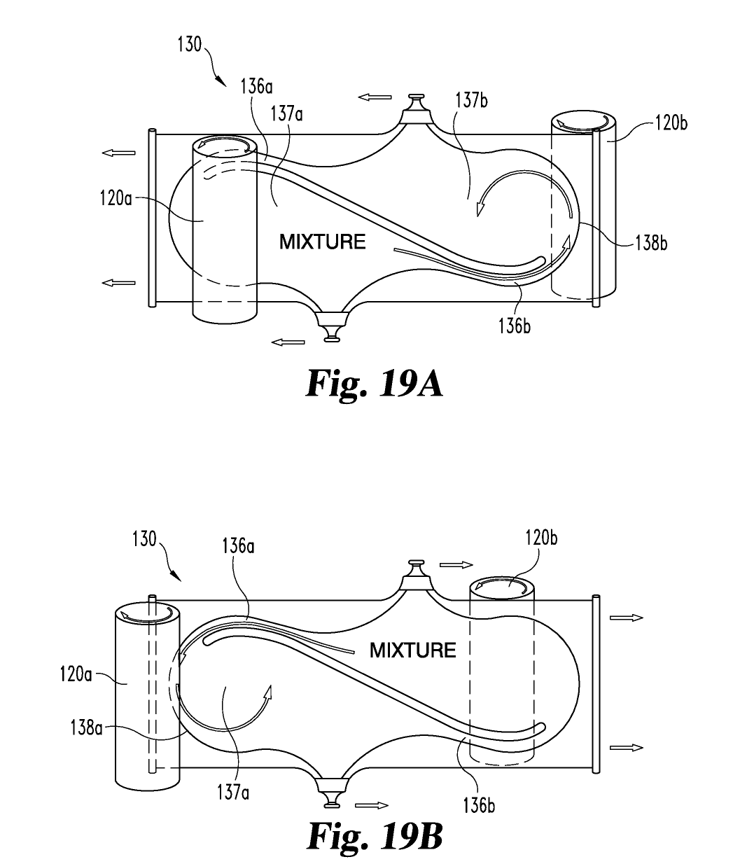

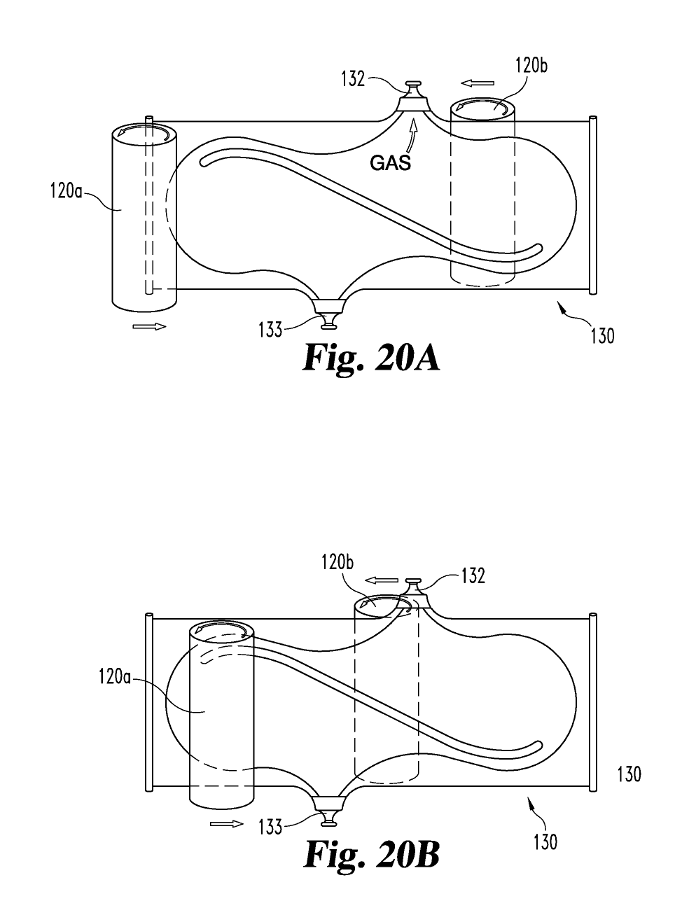

Referring now to FIGS. 19A through 20B, the interaction of rollers 120 with flexible container 130 to achieve mixing and expulsion of both gas and mixture is illustrated. In FIG. 19A, divider 135 has been removed, allowing previously isolated liquid and powder components to be in fluid communication with each other. FIGS. 19A and 19B illustrate the reciprocal motion of flexible container 130 provided by the driving motion of drum 110a, as discussed previously.

FIG. 19A corresponds to the transition from the state depicted in FIG. 17C to the state depicted in FIG. 17B. As drum 110a rotates clockwise, flexible container 130 moves to the left with respect to rollers 120a and 120b. Roller 120b is positioned away from narrowed flow channel 136b, allowing fluid access of the mixture in mixing chamber 137a to mixing chamber 137b via narrowed flow channel 136b.

Simultaneously, as drum 110a rotates clockwise, a pinch point between roller 120a and drum 110a seals off narrowed flow channel 136a and the corresponding fluid access between mixing chambers 137a and 137b. As continued rotation of drum 110a moves flexible container 130 to the left, the pinch point between roller 120a and drum 110a in mixing chamber 137a forces the mixture contained in mixing chamber 137a through narrowed channel 136b and into mixing chamber 137b.

Narrowed channel 136b serves as a mixing catalyst by increasing shear separation due to fluidly developed boundary layers occurring near the walls of narrowed channel 136b. Due to surface friction, the mixture closest to the wall flows at a reduced speed compared to the mixture nearest the center of narrowed chamber 136b. This results in many layers of shear flow separation within the fluid that enhance mixing as the mixture is forced through narrowed channel 136b.

Additionally, the mixture moves from narrowed channel 136b into mixing chamber 137b with an increased flow rate compared to any flow rate or motion within either mixing chamber 137a or 137b. Rounded chamber wall 138b guides the higher flow rate mixture into a swirling motion that intermixes with slower flow rate mixture in mixing chamber 137a. Again, the differential flow rates cause shear mixing to occur. In the illustrated embodiment, rounded chamber walls 138a and 138b are devoid of any corners that could cause any material to become stuck, or stagnate in one area.

When drum 110a has completed a full 90 degree rotation and flexible bag 130 has moved sufficiently far enough to the left that a substantially large portion of the mixture is contained in mixing chamber 137b, the motion of drum 110a is halted and reversed, and a reciprocal process begins. FIG. 19B illustrates the reciprocal process to that previously described, and corresponds to the transition from the state depicted in FIG. 17B to the state depicted in FIG. 17C.

Once the mixture is sufficiently uniform, drum 110a is returned to or halted in a pre-determined position, for example, the drum and roller configuration depicted in FIG. 17C, a gas expulsion process may begin. Gas expulsion tap 132 may be connected to a vacuum device or placed in a fume hood that is suitable to isolate any fumes from the operating theatre. Alternatively, gas can be expelled directly into the operating theatre. Mixing device 99 and flexible container 130 can be oriented such that the gas expulsion tap 132 is vertically oriented at the highest elevation point of flexible container 130. Gas expulsion tap 132 is opened, and gas is allowed to escape from mixing chamber 137b through the tap (FIG. 20A). Biasing member 125 on swivel arm 122c causes roller 120b to apply pressure against flexible container 130 to cause gas to flow through gas expulsion tap 132. As gas is lighter than the mixture, the gas will naturally move towards the top edge of flexible container 130, and substantially all of the gas can be expelled.

Once the gas is expelled, or when a small amount of mixture is expelled through gas expulsion tap 132, gas expulsion tap 132 may be closed, and a mixture expulsion process can begin. Mixture expulsion tap 133 may be connected to a syringe or other suitable device, and mixture expulsion tap 133 is opened. Biasing member 125 coupled with swivel arm 122a causes roller 120a to apply pressure against the mixture contained in mixing chamber 137a (FIG. 20B). Because narrowed flow channel 136b is closed by external pressure from roller 120b, the only path for the mixture is through mixture expulsion tap 133. The mixture can be expelled until the syringe or other device is filled, or until the substantially entire amount of mixture is expelled from flexible container 130. In this way, rollers 120a and 120b serve to both mix the mixture in flexible container 130 and to expel the mixture from flexible container 130. Furthermore, after use, flexible container 130 continues to contain any residual mixture not expelled, simplifying the disposal of the mixture. In the event that all of the mixture is expelled, flexible container 130 is reduced to a substantially flat, flexible object that is easily disposed, taking up minimal disposal space.

It should be understood that the mixing, gas expulsion, and mixture expulsion processes need not be performed in precisely the order presented here. For example, it may be prudent or necessary to expel gas and then continue the mixing process. Also for example, it may be prudent or necessary to continue the mixing process even after some mixture has been expelled.

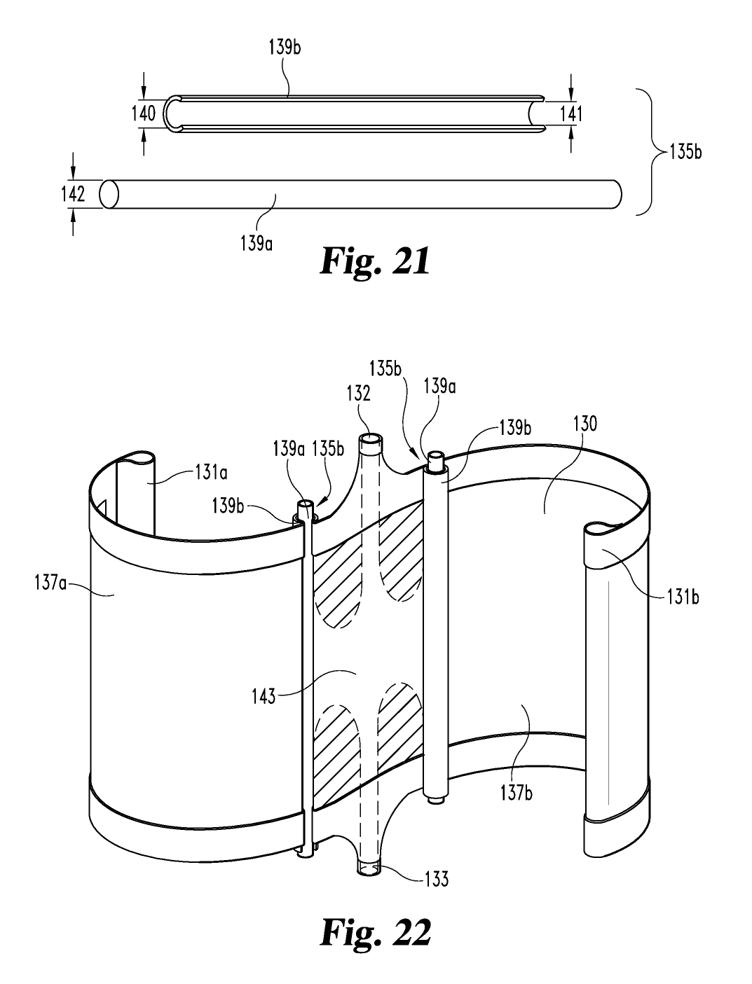

Referring now to FIG. 21, an alternative mechanical embodiment of divider 135 is shown. Divider 135b consists of rod 139a having rod width 142, and c-clip 139b having internal width 140 and opening width 141. Internal width 140 is greater than opening width 141. C-clip 139b can be partially cylindrical, having a circumference that is greater than 180 degrees. Rod 139a is substantially rigid and has rod width 142 which is greater than opening width 141. C-clip 139a is formed of a semi-rigid, yet sufficiently compliant material to allow rod 139a to be inserted into c-clip 139b through opening width 141.

FIG. 22 depicts an alternative embodiment of flexible container 130 having internal flow channel 143 and chambers 137a and 137b. Flow channel 143 fluidly connects chambers 137a and 137b. When mixture flows from one chamber to the second chamber, flow channel 143 provides a narrowing and increased flow rate of the mixture during mixing that may serve to enhance mixing of the components contained in chambers 137a and 137b.

FIG. 22 depicts dividers 135b being engaged in two places with flexible container 130, such that the flexible material of flexible container 130 is positioned between rod 139a and c-clip 139b when rod 139a is inserted into c-clip 139b. Rod width 142 is sufficiently close to internal width 140 such that surface pressure is applied between rod 139a and c-clip 139b and against flexible container 130. The surface pressure is sufficient to create an internal seal within flexible container 130 such that two chambers are formed that do not have fluid access with each other, until such time as dividers 135b are disengaged. As depicted in FIGS. 21 and 22, rod 139a can be longer than c-clip 139b.

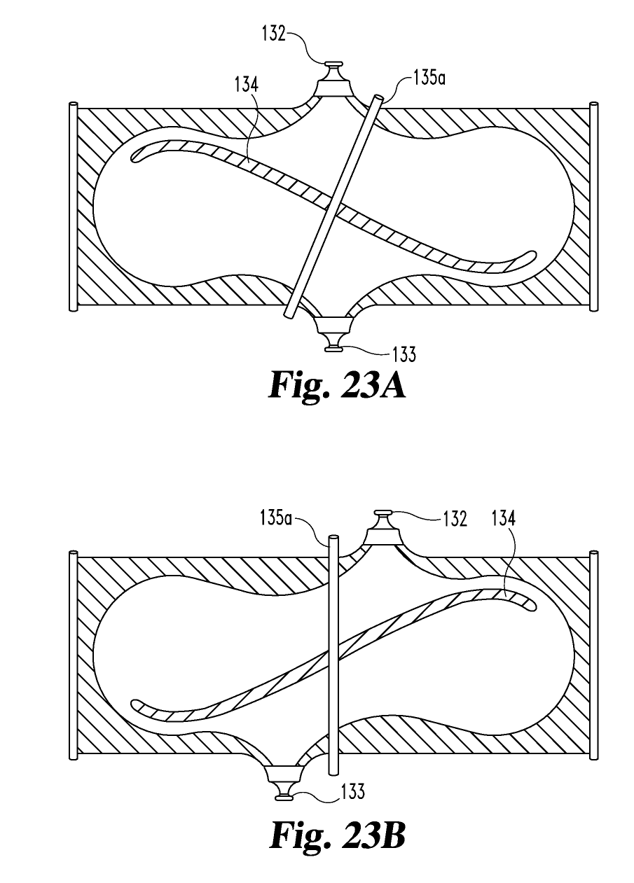

Referring now to FIGS. 23A and 23B, two alternative embodiments of flexible container 130 are presented. FIG. 23A shows flexible container 130 with taps 132 and 133 vertically aligned, and generically-depicted divider 135a being angularly offset. FIG. 23B shows flexible container 130 with taps 132 and 133 being vertically offset, and generically-depicted divider 135a being vertically aligned. It should be appreciated that there are many possible (non-illustrated) configurations of taps and dividers. Variations in consistency, thixotropy, viscosity, etc., could make one type of divider more suitable for a particular material.

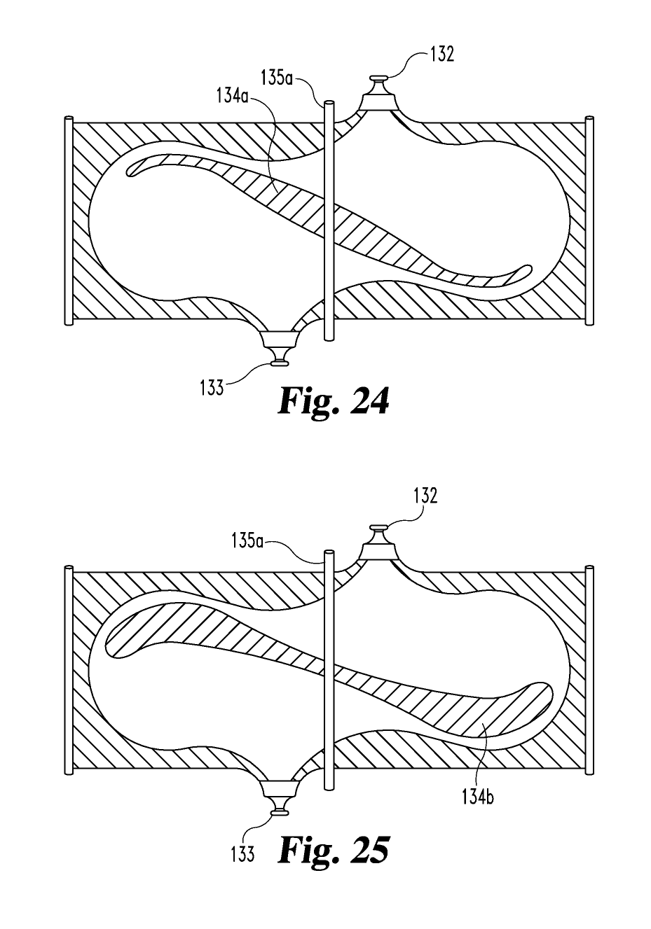

Referring now to FIGS. 24 and 25, two alternative embodiments of flexible container 130 are shown. FIG. 24 shows flexible container 130 with interior fused surface 134a. Interior fused surface 134a is shaped with the middle section being wider then the end sections. FIG. 25 shows flexible container 130 with interior fused surface 134b. Interior fused surface 134b is shaped with the middle section being narrower than the end sections. It should be appreciated that there are many possible (non-illustrated) configurations and shapes of internal fused surfaces.

While the disclosure has been illustrated and described in detail in the drawings and foregoing description, the same is to be considered as illustrative and not restrictive in character, it being understood that only the preferred embodiments have been shown and described and that all changes and modifications that come within the spirit of the disclosure are desired to be protected.

1. A container system for packaging and mixing a first component and a second component reactive with each other to form a bone cement, the container system comprising:
a substantially flat and flexible bag defining a first chamber and a second chamber;
a first flowpath defined by said bag and connecting said first and second chambers;
a second flowpath defined by said bag and connecting said first and second chambers, wherein said first flowpath is located in a separate region of said bag from said second flowpath.

2. The container system of claim 1, further comprising a removable divider constructed and arranged to isolate said first chamber from said second chamber.

3. The container system of claim 2, wherein said first chamber is constructed and arranged for containing a liquid first component and said second chamber is constructed and arranged for containing a powder second component and said divider is constructed and arranged to isolate the first and second components from each other.

4. The container system of claim 1, wherein said bag comprises fused first and second flexible sheets wherein said first and second flowpaths are defined by fused interior surfaces of said first and second sheets.

5. The container system of claim 1, wherein the cross-sectional area of said first flowpath narrows before feeding into said second chamber and the cross-sectional area of said second flowpath narrows before feeding into said first chamber.

6. The container system of claim 1, further comprising:
an first expulsion tap on a first edge of the bag; and
an second expulsion tap on a second edge of the bag.

7. The container system of claim 6, wherein said first and second edges are positionally opposed.

8. The container system of claim 6, wherein said first expulsion tap is fluidly connected with said first chamber and said second expulsion tap is fluidly connected with said second chamber.

9. A system for mixing a first component and a second component to form and dispense a medicament, said system comprising:
a flexible bag containing isolated first and second components reactive with each other to form the medicament;
a mixing device comprising first and second primary pressure surfaces and first and second secondary pressure surfaces; wherein said flexible bag is attached to said first and second secondary pressure surfaces, wherein said first primary pressure surface exerts force on said bag against said first secondary pressure surface and said second primary pressure surface exerts force on said bag against said second secondary pressure surface, wherein said first and second secondary pressure surfaces are curved and wherein relative movement of said primary pressure surfaces with respect to said bag causes mixing of the components within said bag.

10. The system of claim 9, wherein said flexible bag is attached to said first and second secondary pressure surfaces by elongated members fixed to the ends of said bag and elongated channels in said secondary pressure surfaces whereby said elongated members are constructed and arranged to fit into and be retained by said elongated channels.

11. The system of claim 9, wherein said primary pressure surfaces are substantially cylindrical.

12. The system of claim 11, wherein said secondary pressure surfaces are substantially cylindrical.

13. The system of claim 11, further comprising a first swivel arm rotatably connected at a first axis line of said first primary pressure surface and at a second axis line of said first secondary pressure surface.

14. The system of claim 13, wherein said first swivel arm has a length substantially similar to the sum of the radii of said primary and secondary pressure surfaces such that when said first swivel arm rotates, a substantially constant pressure force is applied to said bag between said primary and secondary pressure surfaces.

15. The system of claim 9, wherein said first and second secondary pressure surfaces are rotatable relative to said first and second primary pressure surfaces.

16. The system of claim 15, further comprising a mechanical control means to rotate said first secondary pressure surface about its axis, wherein said mechanical control means is selected from the group consisting of gears, chains, belts, and kinematic links.

17. The system of claim 16, whereby movement of said first primary pressure surface causes mixing of the components within said bag.

18. A method of mixing and expelling medicament comprising:
fixing a substantially flat and flexible bag having a first and second components reactive with each other to form bone cement to a mixing device including first and second primary pressure surfaces and first and second secondary pressure surfaces wherein the bag is attached to each of the secondary pressure surfaces, whereby the secondary pressure surfaces are curved; and
actuating the mixing device to cause relative movement between the bag and the first primary pressure surface wherein the first primary pressure surface creates a pinch point on the bag between the first primary pressure surface and the first secondary pressure surface causing the components within the bag to move from a first chamber of the bag to a second chamber of the bag.

19. The method of claim 18, further comprising actuating the mixing device to cause relative movement between the bag and the second primary pressure surface wherein the second primary pressure surface creates a pinch point on the bag between the second primary pressure surface and the second secondary pressure surface causing the components within the bag to move from the second chamber of the bag to the first chamber of the bag.

20. A device for sealing and subdividing a flexible bag, comprising:
a first elongated member having a rounded pressure surface and a maximum width,
a substantially rigid, second elongated member constructed and arranged to fit around said rounded pressure surface and the flexible bag wrapped around said rounded pressure surface, wherein said second member has an opening width that is less than said maximum width.
